(19) United States
(12) Patent Application Publication
(10) Pub. No.: US 2017/0360066 A1
(43) Pub. Date: Dec. 21, 2017

(54) BEVERAGE PRODUCT WITH POTASSIUM SODIUM TARTRATE

(71) Applicant: KRAFT FOODS GROUP BRANDS LLC, Chicago, IL (US)

(72) Inventors: Sara A. ALDAOUS, Tarrytown, NY (US); Maria Del Pilar COBOS, Tarrytown, NY (US); Karl RAGNARSSON, Tarrytown, NY (US)

(73) Assignee: KRAFT FOODS GROUP BRANDS LLC, Chicago, IL (US)

(21) Appl. No.: 15/527,614

(22) PCT Filed: Nov. 17, 2015
(86) PCT No.: PCT/US15/61049

§ 371 Date: May 17, 2017

Related U.S. Application Data
(60) Provisional application No. 62/080,744, filed on Nov. 17, 2014.

(51) Int. Cl. A23L 2/02; A23L 2/56; A23L 2/60

(52) U.S. Cl. CPC A23L 2/02; A23L 2/60; A23L 2/56; A23V 2002/00

(57) ABSTRACT

A beverage product comprising sodium potassium tartrate; citrus juice; and sweetener; wherein the beverage product contains substantially all natural ingredients and has a shelf life of at least 6 months.

### CROSS-REFERENCE TO RELATED APPLICATION

This application claims the benefit of U.S. Provisional Patent Application Ser. No. 62/080,744, entitled “Beverage Product with Potassium Sodium Tartrate,” filed on Nov. 17, 2014, the entire content of which is incorporated herein by reference.

### BACKGROUND OF THE INVENTION

The present invention generally relates to beverage products including potassium sodium tartrate, also known as Rochelle salt.

### BRIEF SUMMARY OF THE INVENTION

According to some embodiments of the present invention, a beverage product includes sodium potassium tartrate, citrus juice, and sweetener. In some embodiments, the beverage product includes natural ingredients and has a shelf life of at least 6 months. In some embodiments, the beverage product consists essentially of natural ingredients.

In certain embodiments, the sodium potassium tartrate is present in an amount of about 0.01 wt % to about 2 wt % of the beverage product of any of the embodiments described herein, or about 0.09 wt % to about 0.1 wt % of the beverage product of any of the embodiments described herein.

In some embodiments, the beverage product of any of the embodiments described herein includes citrus flavor. In some embodiments, the beverage product of any of the embodiments described herein includes citrus juice in an amount of about 5 wt % to about 15 wt % of the beverage product. In some embodiments, the citrus juice comprises lemon juice.

In certain embodiments, the beverage product of any of the embodiments described herein has a pH of about 2.5 to about 3.5, or a pH of about 3.

In some embodiments, the beverage product of any of the embodiments described herein includes an acid. In some embodiments, the acid includes citric acid and/or malic acid. The acid may be present in an amount of about 0.09 wt % to about 0.13 wt % of the beverage product of any of the embodiments described herein. In some embodiments, the beverage product of any of the embodiments described herein has an acidity of about 0.3% to about 0.6%

In some embodiments, the beverage product of any of the embodiments described herein has a shelf life of at least about 9 months, or at least about 12 months.

In some embodiments, the beverage product of any of the embodiments described herein includes water. In some embodiments, the sweetener includes sucrose.

### DETAILED DESCRIPTION OF THE INVENTION

Methods and compositions of the present invention relate to beverage products containing potassium sodium tartrate. In some embodiments, the beverage product also includes citrus juice and/or citrus flavor. In some embodiments, the beverage product includes, consists of, or consists essentially of natural ingredients. In some embodiments, the beverage product includes no artificial ingredients.

In order to provide a desirable pH and organoleptic properties such as balanced flavor and mouthfeel, beverage products may include a buffering salt. Inclusion of a buffering salt may be particularly useful in beverages including citrus juice and/or citrus flavor for a number of reasons. For example, citrus juice and/or citrus flavor may contribute to the acidity of the beverage product and lower the pH to a level which results in an unbalanced flavor and/or mouthfeel. Additionally, citrus juices and/or citrus flavors may be susceptible to oxidation and deterioration over time at low pH and/or with high thermal processing.

Buffering salts such as potassium citrate have been included in citrus beverages to address these issues. However, such traditional buffering salts are not considered natural ingredients and no suitable naturally-derived substitutes were known. As used herein, natural ingredients are understood to mean those derived from natural sources.

Surprisingly, it has been found that potassium sodium tartrate may be used as a natural ingredient to provide unexpected effectiveness as a buffering agent and stabilizer, as discussed in further detail below. Potassium sodium tartrate may be considered a natural ingredient as it may be derived from a natural crystalline acid deposited on the inside of wine barrels.

Beverage Product

In some embodiments, a beverage product of the present invention is formulated to provide desirable organoleptic properties such as a balanced flavor and mouthfeel, and/or to provide a desirable pH, and/or desired product stability. In some embodiments, the beverage product includes, consists of, or consists essentially of natural ingredients.

In some embodiments, a beverage product of the present invention includes solvent, sweetener, acid, buffering salt, citrus juice, and/or flavor.

In some embodiments, a beverage product of the present invention is formulated to be a ready-to-drink composition. In some embodiments, a beverage product of the present invention is formulated to provide a concentrate (e.g., a liquid composition that can be diluted with an aqueous, potable liquid, to provide a flavored beverage). In some embodiments, the concentrated liquid flavoring is formulated to be diluted in a beverage by a factor of about 40 to about 160 times to provide a flavored beverage, which can be, for example, an 8 ounce beverage.

In some embodiments, the beverage product of the present invention is a powdered beverage concentrate product. In some embodiments, the powdered beverage concentrate product does not include the solvent, but includes some or all of the remaining components described herein in the same or similar relative proportions. The powdered beverage concentrate product may be added to a liquid in a desired amount to prepare a beverage.

A beverage product may be formulated to provide a desired pH. Beverage products of some embodiments of the present invention may have a pH of about 2.0 to about 4.4; about 2.2 to about 4.0; about 2.5 to about 3.5; about 2.0; about 2.2; about 2.5; about 3; about 3.5; or about 4.4.

In some embodiments, a beverage product is formulated to provide a desired acidity. In some embodiments, a beverage product has an acidity of about 0.1% to about 1%; about 0.1% to about 0.9%; about 0.1% to about 0.8%; about 0.2% to about 0.7%; about 0.3% to about 0.6%; about 0.4% to about 0.5%; about 0.1%; about 0.15%; about 0.2%; about 0.25%; about 0.3%; about 0.35%; about 0.4%; about 0.45%; about 0.5%; about 0.55%; about 0.6%; about 0.65%; about 0.7%; about 0.75%; about 0.8%; about 0.85%; about 0.9%; about 0.95%; or about 1%.

In some embodiments, a beverage product is formulated to provide a desired brix/acid ratio. In some embodiments, the beverage product has a brix/acid ratio of about 13 to about 20; about 14 to about 19; about 15 to about 18; about 16 to about 17; about 13; about 14; about 15; about 16; about 17; about 18; about 19; or about 20.

In some embodiments, a beverage product of the present invention has a shelf life of at least about 6 months, at least about 9 months, at least about 12 months, at least about 15 months, at least about 18 months, or at least about 2 years. In some embodiments, shelf life for an ambient beverage product is understood to refer to storage at temperature of about 70° F. and a relative humidity of about 50%.

Components which may be used to achieve these properties in the beverage product of embodiments of the present invention are described in more detail below.

Buffering Salt

Beverage products of the present invention may include one or more buffering salts. In some embodiments, buffering salts are included in an amount appropriate to provide a desirable pH, balanced flavor, mouthfeel, and/or product stability. In some embodiments, buffering salts can be added to the beverage product to provide for increased acid content at a desired pH, which may be particularly useful for beverage products containing a citrus juice and/or flavoring.

In some embodiments, the beverage product includes a natural buffering salt. In some embodiments, the natural buffering salt includes, consists of, or consists essentially of potassium sodium tartrate. Potassium sodium tartrate, also known as Rochelle salt, has the formula KNaC₄H₄O₆.4H₂O and has traditionally been used medicinally as a laxative, in the process of silvering mirrors, and as a component in wall plaster and cigarette paper.

In some embodiments, the beverage product may include additional buffering salts, such as a conjugated base of an acid, gluconate, acetate, phosphate or any salt of an acid (e.g., sodium citrate and potassium citrate). In other instances, an undissociated salt of the acid can buffer the beverage product. In some embodiments, the beverage product does not include sodium citrate or potassium citrate.

In some embodiments, a buffering salt may be included in an amount relative to the acid content. In some embodiments, a beverage product includes a buffering salt in an amount of about 0.01 wt % to about 3 wt % of the beverage product; about 0.01 wt % to about 2.5 wt % of the beverage product; about 0.01 wt % to about 2 wt % of the beverage product; about 0.01 wt % to about 1.5 wt % of the beverage product; about 0.01 wt % to about 1 wt % of the beverage product; about 0.01 wt % to about 0.5 wt % of the beverage product; about 0.02 wt % to about 0.3 wt % of the beverage product; about 0.05 wt % to about 0.15 wt % of the beverage product; about 0.07 wt % to about 0.12 wt % of the beverage product; about 0.09 wt % to about 0.1 wt % of the beverage product; about 0.01 wt % of the beverage product; about 0.02 wt % of the beverage product; about 0.05 wt % of the beverage product; about 0.07 wt % of the beverage product; about 0.08 wt % of the beverage product; about 0.09 wt % of the beverage product; about 0.1 wt % of the beverage product; about 0.12 wt % of the beverage product; about 0.15 wt % of the beverage product; about 0.2 wt % of the beverage product; about 0.3 wt % of the beverage product; about 0.3 wt % of the beverage product; or about 0.5 wt % of the beverage product.

Acid

Beverage products of the present invention may include one or more acids. In some embodiments, the acidulant can include, for example, any food grade organic or inorganic acid, such as but not limited to sodium acid sulfate, citric acid, malic acid, succinic acid, acetic acid, hydrochloric acid, adipic acid, tartaric acid, fumaric acid, phosphoric acid, lactic acid, salts thereof, and combinations thereof. The selection of the acid may depend, at least in part, on the desired pH of the beverage product. In another embodiment, the amount of acid included in the beverage product may depend on the strength of the acid. For example, a larger quantity of lactic acid would be needed to reduce the pH of the beverage product than a stronger acid, such as phosphoric acid. In some embodiments, the amount of acid may depend on the other components included in the beverage product, such as citrus juice and/or flavoring. Such components may contain acid themselves, and therefore less additional acid would be needed or desired in the beverage product. In some embodiments, a beverage product includes acid in an amount to provide a beverage product with a desired acidity level and/or pH.

In some embodiments, a beverage product includes an acid in an amount of about 0.01 wt % to about 5 wt % of the beverage product; about 0.01 wt % to about 3 wt % of the beverage product; about 0.01 wt % to about 2 wt % of the beverage product; about 0.01 wt % to about 1 wt % of the beverage product; about 0.01 wt % to about 0.7 wt % of the beverage product; about 0.05 wt % to about 0.6 wt % of the beverage product; about 0.07 wt % to about 0.5 wt % of the beverage product; about 0.08 wt % to about 0.4 wt % of the beverage product; about 0.09 wt % to about 0.4 wt % of the beverage product; about 0.09 wt % to about 0.3 wt % of the beverage product; about 0.09 wt % to about 0.2 wt % of the beverage product; about 0.09 wt % to about 0.13 wt % of the beverage product; about 0.1 wt % to about 0.3 wt % of the beverage product; about 0.01 wt % of the beverage product; about 0.02 wt % of the beverage product; about 0.03 wt % of the beverage product; about 0.04 wt % of the beverage product; about 0.05 wt % of the beverage product; about 0.06 wt % of the beverage product; about 0.07 wt % of the beverage product; about 0.08 wt % of the beverage product; about 0.09 wt % of the beverage product; about 0.1 wt % of the beverage product; about 0.2 wt % of the beverage product; about 0.3 wt % of the beverage product; about 0.4 wt % of the beverage product; about 0.5 wt % of the beverage product; about 0.6 wt % of the beverage product; about 0.7 wt % of the beverage product; about 0.8 wt % of the beverage product; about 0.9 wt % of the beverage product; about 1 wt % of the beverage product; about 2 wt % of the beverage product; about 3 wt % of the beverage product; about 4 wt % of the beverage product; or about 5 wt % of the beverage product.

Flavor

Beverage products of some embodiments of the present invention may include juices and other flavors. As used herein, juice is understood to include regular strength juice as well as juice concentrates. In some embodiments, the beverage products include natural juices and/or natural flavors. In some embodiments, a beverage product includes citrus juice. Any suitable citrus juices may be used, including orange, lemon, lime, grapefruit, and combinations thereof. In some embodiments, a beverage product includes juice in an amount of about 0.1 wt % to about 25 wt % of the beverage product; about 0.1 wt % to about 20 wt % of the beverage product; about 0.1 wt % to about 15 wt % of the beverage product; about 0.5 wt % to about 12 wt % of the beverage product; about 0.5 wt % to about 11 wt % of the beverage product; about 0.5 wt % to about 10 wt % of the beverage product; about 0.5 wt % to about 8 wt % of the beverage product; about 0.5 wt % to about 6 wt % of the beverage product; about 0.5 wt % to about 5 wt % of the beverage product; about 0.5 wt % to about 4 wt % of the beverage product; about 0.5 wt % to about 3 wt % of the beverage product; about 0.5 wt % to about 2 wt % of the beverage product; about 0.5 wt % to about 1.5 wt % of the beverage product; about 5 wt % to about 15 wt % of the beverage product, about 5 wt % to about 12 wt % of the beverage product; about 7 wt % to about 10 wt % of the beverage product; about 0.1 wt % of the beverage product; about 0.2 wt % of the beverage product; about 0.3 wt % of the beverage product; about 0.4 wt % of the beverage product; about 0.5 wt % of the beverage product; about 0.6 wt % of the beverage product; about 0.7 wt % of the beverage product; about 0.8 wt % of the beverage product; about 0.9 wt % of the beverage product; about 1 wt % of the beverage product; about 1.5 wt % of the beverage product; about 2 wt % of the beverage product; about 3 wt % of the beverage product; about 4 wt % of the beverage product; about 5 wt % of the beverage product; about 7 wt % of the beverage product; about 10 wt % of the beverage product; about 15 wt % of the beverage product; about 20 wt % of the beverage product; or about 25 wt % of the beverage product.

In some embodiments, beverage products of the present invention include flavorings, such as, for example, hazelnut, praline, vanilla, French vanilla, almond, caramel, pumpkin, creme brulee, mocha, mint, peppermint, gingerbread, toffee, Irish cream, cinnamon, maple, coconut, amaretto, chocolate, butterscotch, egg nog, tiramisu, praline, fruit (e.g., peach, raspberry, blueberry, lemon, strawberry, cherry, orange, lime), coffee, and tea, and combinations thereof

Beverage products of some embodiments may include flavor in an amount of 0.01 wt % to about 25 wt % of the beverage product; about 0.01 wt % to about 20 wt % of the beverage product; about 0.01 wt % to about 15 wt % of the beverage product; about 0.01 wt % to about 10 wt % of the beverage product; about 0.01 wt % to about 5 wt % of the beverage product; about 0.01 wt % to about 3 wt % of the beverage product; about 0.01 wt % to about 1.5 wt % of the beverage product; about 0.05 wt % to about 1 wt % of the beverage product; about 0.01 wt % to about 0.5 wt % of the beverage product; about 0.01 wt % to about 0.2 wt % of the beverage product; about 0.01 wt % to about 0.1 wt % of the beverage product; about 0.01 wt % to about 0.07 wt % of the beverage product; about 0.01 wt % to about 0.05 wt % of the beverage product; about 0.02 wt % to about 0.04 wt % of the beverage product; about 0.01 wt % of the beverage product; about 0.02 wt % of the beverage product; about 0.03 wt % of the beverage product; about 0.04 wt % of the beverage product; about 0.05 wt % of the beverage product; about 0.07 wt % of the beverage product; about 1 wt % of the beverage product; about 1.5 wt % of the beverage product; about 3 wt % of the beverage product; about 5 wt % of the beverage product; about 10 wt % of the beverage product; about 15 wt % of the beverage product; about 20 wt % of the beverage product; or about 25 wt % of the beverage product.

Sweetener

Beverage products of the present invention may also include one or more sweeteners. Suitable sweeteners may include nutritive and/or non-nutritive sweeteners. In some embodiments, the beverage product includes high intensity sweeteners. In some embodiments, the beverage product includes natural sweeteners. In some embodiments, the beverage product includes artificial sweeteners. Suitable sweeteners may include, for example, sugars including maltose, sucrose, glucose, fructose, invert sugars and mixtures thereof. Additional suitable sweeteners may include erythritol, glycerol, maltitol, mannitol, monatin, sorbitol, stevia, tagatose, xylitol, and mixtures thereof. Suitable artificial sweeteners may include, for example, saccharin, cyclamates, sucralose, acetosulfam, acesulfame-K, L-aspartyl-L-phenylalanine lower alkyl ester sweeteners (e.g., aspartame), L-aspartyl-D-alanine amides disclosed in U.S. Pat. No. 4,411,925 to Brennan et al., L-aspartyl-D-serine amides disclosed in U.S. Pat. No. 4,399,163 to Brennan et al., L-aspartyl-L-1-hydroxymethyl-alkaneamide sweeteners disclosed in U.S. Pat. No. 4,338,346 to Brand, L-aspartyl-l-hydroxyethylakaneamide sweeteners disclosed in U.S. Pat. No. 4,423,029 to Rizzi, L-aspartyl-D-phenylglycine ester and amide sweeteners disclosed in European Patent Application 168,112 to J. M. Janusz, published Jan. 15, 1986, and the like.

Beverage products may include sweeteners in an amount of about 0.5 wt % to about 25 wt % of the beverage product; about 1 wt % to about 20 wt % of the beverage product; about 3 wt % to about 17 wt % of the beverage product; about 5 wt % to about 15 wt % of the beverage product; about 7 wt % to about 13 wt % of the beverage product; about 5 wt % to about 10 wt % of the beverage product; about 0.5 wt % of the beverage product; about 1 wt % of the beverage product; about 3 wt % of the beverage product; about 5 wt % of the beverage product; about 7 wt % of the beverage product; about 10 wt % of the beverage product; about 13 wt % of the beverage product; about 15 wt % of the beverage product; about 17 wt % of the beverage product; about 20 wt % of the beverage product; or about 25 wt % of the beverage product.

Solvent

The beverage product of some embodiments of the present invention may also a solvent or solvent system. Suitable solvents may include, for example, one or more solvents selected from the group consisting of water, alcohol, ethanol, and any combinations thereof.

The amount of solvent used may depend on whether the beverage product is a ready to drink beverage or a beverage concentrate. Any suitable amount of solvent may be included in embodiments of the present invention to achieve the desired organoleptic properties.

Additional Ingredients

Optionally, colors can be included in the beverage products. The colors can include artificial colors, natural colors, or a combination thereof and can be included in any suitable amount to achieve the desired color characteristics.

If desired, the beverage product may include additional components, such as salts, preservatives, viscosifiers, surfactants, stimulants, antioxidants, caffeine, electrolytes (including salts), nutrients (e.g., vitamins and minerals), stabilizers, gums, and the like. In some embodiments, preservatives, such as EDTA, sodium benzoate, potassium sorbate, sodium hexametaphosphate, nisin, natamycin, polylysine, and the like may be included, if desired.

Effect of Potassium Sodium Tartrate

It has been found that potassium sodium tartrate may be used as a natural ingredient to provide unexpected effectiveness as a buffering agent and stabilizer. Other natural salts, such as sodium chloride, have been tested in beverage products and have been found to be ineffective for buffering and accelerated degradation of the flavor.

### Exemplary Embodiment

In an exemplary embodiment, potassium sodium tartrate is included in a beverage product to replace the existing artificial buffering salt. In this embodiment, the beverage product includes also a citrus juice, citrus flavor, citric acid, sucrose, and water. In one embodiment, the citrus juice results in the beverage product having a pH low enough to negatively impact the stability of the product and flavor; citrus juice and citrus flavor may be particularly susceptible to oxidation and deterioration over time at low pH. In this embodiment, potassium sodium tartrate was added to the beverage product as a natural buffering salt, to buffer the pH to a more stable level such as a pH of about 3.0. The amount of potassium sodium tartrate added was dictated by the desire to maintain the acidity of the product at the same level. Surprisingly, the addition of potassium sodium tartrate improved the stability of the flavor beyond the stabilizing effects attributed to the pH level. The potassium sodium tartrate also provided a unique tartness to the beverage product in this embodiment.

As used herein, the term “about” is understood to mean +10% of the value referenced. For example, “about 45%” is understood to literally mean 40.5% to 49.5%.

As used herein, the term “substantially all” is understood to mean at least 90%, and preferably greater than 95%.

It will be appreciated by those skilled in the art that changes could be made to the exemplary embodiments shown and described above without departing from the broad inventive concept thereof. It is understood, therefore, that this invention is not limited to the exemplary embodiments shown and described, but it is intended to cover modifications within the spirit and scope of the present invention as defined by the claims. For example, specific features of the exemplary embodiments may or may not be part of the claimed invention and features of the disclosed embodiments may be combined.

It is to be understood that at least some of the figures and descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

The claims directed to the method of the present invention should not be limited to the performance of their steps in the order written except where expressly stated, and one skilled in the art can readily appreciate that the steps may be varied and still remain within the spirit and scope of the present invention.

### EXAMPLE 1

A beverage product was prepared according to the following formulation:

| Ingredients | Wt % |
|---|---|
| Water | 88 |
| Liquid sucrose | 10 |
| Acid, 50% | 0.2 |
| Citrus juice | 1.1 |
| Potassium sodium tartrate | 0.1 |
| Natural flavor | 0.6 |
| Total | 100 |

The beverage product exhibited a shelf life of at least 12 months, and has a brix/acid ratio of about 16.

EXAMPLE 2

A sensory evaluation was conducted on four different formulations. The formulations are as follows:

1) Control Sample (commercial beverage product including high fructose corn syrup and potassium citrate);

2) Sample with no buffer (includes sugar);

3) Sample with potassium citrate (includes sugar instead of high fructose corn syrup); and,

4) Sample with potassium sodium tartrate (includes sugar and no high fructose corn syrup).

Respondents were asked to taste three samples stored at three different temperatures (40° F., 70° F., and 90° F.) in a random order and rate how they differ from the control (40° F.). The tests were repeated for samples at four weeks, eight weeks, and 12 weeks. The rating is done using a 10 point scale: 1 no difference and 10 large difference. Each respondent indicated if the difference was based on flavor, sweetness, sourness, or development of off notes over time.

All parameters were kept consistent in the 3 samples (50 calories with sugar) to limit variability coming from other ingredients.

Data have shown an improvement of the stability of the product over time especially at ambient temperatures. The results are shown below:

| | Potassium | | | Potassium | | | | | | | | | |
|---|---|---|---|---|---|---|---|---|---|---|---|---|---|
| | Sodium | | | Citrate | | | Potassium | | | 50 Cal | | | |
| DoD | Tartrate | | | Control | | | Citrate | | | without | | | |
| Sub- | (50 Cal) | | | (60 Cal) | | | (50 Cal) | | | buffer | | | |
| ject | 4 | 8 | 12 | 4 | 8 | 12 | 4 | 8 | 12 | 4 | 8 | 12 | 37° F. |
| | 1 | 1 | 1 | 1 | 2 | 1 | 1 | 2 | 1 | 3 | 1 | 1 | |
| | 1 | 3 | 1 | 1 | 3 | 2 | 1 | 1 | 2 | 1 | 3 | 3 | |
| | 2 | 2 | 4 | 1 | 1 | 2 | 1 | 1 | 1 | 1 | 2 | 1 | |
| | 1 | 1 | 2 | 1 | 2 | 3 | 1 | 2 | 1 | 3 | 1 | 1 | |
| | 2 | 1 | 2 | 5 | 1 | 1 | 2 | 3 | 1 | 1 | 1 | 1 | |
| | | 1 | 2 | | 1 | 1 | | 1 | 1 | | 1 | 1 | |
| | | 1 | 1 | | 1 | 1 | | 1 | 1 | | 1 | 1 | |
| | 1 | 1 | 2 | 2 | 2 | 2 | 1 | 2 | 1 | 2 | 1 | 1 | |

| | | | | Potassium | | | | | | | | | |
|---|---|---|---|---|---|---|---|---|---|---|---|---|---|
| | Potassium | | | Citrate | | | Potassium | | | 50 Cal | | | |
| DoD | Sodium | | | Control | | | Citrate | | | without | | | |
| Sub- | Tartrate | | | (60 Cal) | | | (50 Cal) | | | buffer | | | |
| ject | 4 | 8 | 12 | 4 | 8 | 12 | 4 | 8 | 12 | 4 | 8 | 12 | 70° F. |
| | 1 | 2 | 1 | 4 | 2 | 3 | 2 | 2 | 3 | 1 | 2 | 1 | |
| | 1 | 2 | 1 | 4 | 3 | 2 | 1 | 3 | 5 | 1 | 1 | 2 | |
| | 1 | 2 | 1 | 2 | 1 | 1 | 1 | 3 | 4 | 2 | 1 | 1 | |
| | 2 | 2 | 1 | 1 | 1 | 2 | 1 | 2 | 3 | 1 | 3 | 1 | |
| | 1 | 2 | 3 | 4 | 2 | 1 | 2 | 1 | 1 | 2 | 3 | 4 | |
| | | 2 | 3 | | 2 | 1 | | 2 | 1 | | 2 | 1 | |
| | | 1 | 1 | | 1 | 1 | | 1 | 2 | | 2 | 1 | |
| | 1 | 2 | 2 | 3 | 2 | 2 | 1 | 2 | 3 | 1 | 2 | 2 | |

| | | | | Potassium | | | | | | | | | |
|---|---|---|---|---|---|---|---|---|---|---|---|---|---|
| | Potassium | | | Citrate | | | Potassium | | | 50 Cal | | | |
| DoD | Sodium | | | Control | | | Citrate | | | without | | | |
| Sub- | Tartrate | | | (60 Cal) | | | (50 Cal) | | | buffer | | | |
| ject | 4 | 8 | 12 | 4 | 8 | 12 | 4 | 8 | 12 | 4 | 8 | 12 | 90° F. |
| | 1 | 4 | 2 | 2 | 3 | 3 | 3 | 3 | 4 | 2 | 1 | 1 | |
| | 2 | 2 | 3 | 3 | 1 | 1 | 1 | 1 | 3 | 1 | 3 | 5 | |
| | 3 | 2 | 2 | 3 | 4 | 2 | 2 | 1 | 3 | 3 | 4 | 2 | |
| | 3 | 2 | 1 | 1 | 3 | 3 | 1 | 2 | 5 | 2 | 2 | 1 | |
| | 2 | 2 | 2 | 5 | 2 | 1 | 2 | 4 | 2 | 2 | 6 | 8 | |
| | | 3 | 4 | | 3 | 3 | | 4 | 5 | | 2 | 1 | |
| | | 2 | 3 | | 1 | 4 | | 2 | 2 | | 4 | 4 | |
| | 2 | 2 | 2 | 3 | 2 | 2 | 2 | 2 | 3 | 2 | 3 | 3 | |

We claim:

1. A beverage product comprising:
sodium potassium tartrate;
citrus juice; and
sweetener;
wherein the beverage product includes natural ingredients and has a shelf life of at least 6 months.

2. The beverage product of claim 1, wherein the beverage product consists essentially of natural ingredients.

3. The beverage product of claim 1, wherein the sodium potassium tartrate is present in an amount of about 0.01 wt % to about 2 wt % of the beverage product.

4. The beverage product of claim 1, wherein the sodium potassium tartrate is present in an amount of about 0.09 wt % to about 0.1 wt % of the beverage product.

5. The beverage product of claim 1, further comprising citrus flavor.

6. The beverage product of claim 1, wherein the beverage product has a pH of about 2.5 to about 3.5.

7. The beverage product of claim 1, wherein the beverage product has a pH of about 3.

8. The beverage product of claim 1, wherein the beverage product includes citrus juice in an amount of about 5 wt % to about 15 wt % of the beverage product.

9. The beverage product of claim 1, wherein the citrus juice comprises lemon juice.

10. The beverage product of claim 1, wherein the beverage product has a shelf life of at least about 9 months.

11. The beverage product of claim 1, wherein the beverage product has a shelf life of at least about 12 months.

12. The beverage product of claim 1, further comprising an acid.

13. The beverage product of claim 12, wherein the acid comprises citric acid and/or malic acid.

14. The beverage product of claim 12, wherein the acid is present in an amount of about 0.09 wt % to about 0.13 wt % of the beverage product.

15. The beverage product of claim 1, wherein the beverage product has an acidity of about 0.3% to about 0.6%

16. The beverage product of claim 1, further comprising water.

17. The beverage product of claim 1, wherein the sweetener comprises sucrose.
